(19) United States
(12) Patent Application Publication
(10) Pub. No.: US 2025/0333238 A1
(43) Pub. Date: Oct. 30, 2025

(54) MULTIPLE-SHELL TANK AND HEAT INSULATION MATERIAL SUPPLY METHOD FOR MULTIPLE-SHELL TANK

(71) Applicant: KAWASAKI JUKOGYO KABUSHIKI KAISHA, Kobe-shi, Hyogo (JP)

(72) Inventors: Takeshi EGAMI, Kobe-shi (JP); Takahiro YAMAGUCHI, Kobe-shi (JP); Shunsuke KIKUGAWA, Kobe-shi (JP)

(73) Assignee: KAWASAKI JUKOGYO KABUSHIKI KAISHA, Kobe-shi, Hyogo (JP)

(21) Appl. No.: 18/871,596

(22) PCT Filed: Jun. 5, 2023
(86) PCT No.: PCT/JP2023/020895

§ 371 Date: Dec. 4, 2024

(30) Foreign Application Priority Data
Jun. 9, 2022 (JP) 2022-093923

(51) Int. Cl. B65D 90/02

(52) U.S. Cl. CPC B65D 90/028

(57) ABSTRACT

A multiple-shell tank includes: an inner tank that stores a liquefied gas; an intermediate tank that covers the inner tank and forms a first heat insulating space between the intermediate tank and the inner tank; an outer tank that covers the intermediate tank and forms a second heat insulating space between the outer tank and the intermediate tank; and a communication part enabling an external space that is a space outside the multiple-shell tank and the first heat insulating space to communicate with each other.

### TECHNICAL FIELD

The present disclosure relates to a multiple-shell tank that stores a low-temperature liquefied gas and a heat insulation material supply method for a multiple-shell tank.

### BACKGROUND ART

Conventionally, a tank that stores a low-temperature liquefied gas is known. Patent Literature 1 discloses, as such a tank, an LNG tank that stores a liquefied natural gas (LNG). In the technique, an LNG tank has a double shell tank structure including an inner tank that stores the LNG and an outer tank that covers the inner tank. A heat insulating space is formed between the inner tank and the outer tank, and the heat insulating space is filled with heat insulation material such as perlite and nitrogen gas.

In the LNG tank described in Patent Literature 1, by opening a filling hole in the outer tank in advance, heat insulation material can be replenished from the opening to the heat insulating space. On the other hand, when a cryogenic liquefied gas such as liquefied hydrogen is stored, hydrogen cannot be stably stored in a liquid state in a double shell tank similar to the LNG tank, and thus a triple-shell tank, further including an intermediate layer between the inner tank and the outer tank, is used. In this case, a first heat insulating space is disposed between the inner tank and the intermediate tank, and a second heat insulating space is disposed between the intermediate tank and the outer tank.

### CITATION LIST

### Patent Literature

Patent Literature 1: JP 2016-125508 A

### SUMMARY OF INVENTION

An object of the present disclosure is to provide a structure and a method suitable for supplying heat insulation material to a heat insulating space formed between an inner tank and an intermediate tank of a multiple-shell tank.

A multiple-shell tank according to an aspect of the present disclosure includes: an inner tank that stores a liquefied gas; an intermediate tank that covers the inner tank and forms a first heat insulating space between the intermediate tank and the inner tank; an outer tank that covers the intermediate tank and forms a second heat insulating space between the outer tank and the intermediate tank; and a communication part enabling an external space and the first heat insulating space to communicate with each other, the external space being a space outside the multiple-shell tank.

In addition, a heat insulation material supply method for a multiple-shell tank according to another aspect of the present disclosure is a heat insulation material supply method for a multiple-shell tank including an inner tank that stores a liquefied gas; an intermediate tank that covers the inner tank and forms a first heat insulating space between the intermediate tank and the inner tank; and an outer tank that covers the intermediate tank and forms a second heat insulating space between the outer tank and the intermediate tank, the method including: supplying heat insulation material from an external space to the first heat insulating space through a communication part enabling the external space and the first heat insulating space to communicate with each other, the external space being a space outside the multiple-shell tank.

### BRIEF DESCRIPTION OF DRAWINGS

FIG. 1 is a longitudinal cross-sectional view of a multiple-shell tank according to an embodiment of the present disclosure.

FIG. 2 is a schematic cross-sectional view of the heat insulation material supply unit according to the embodiment of the present disclosure.

FIG. 3 is a plan view illustrating a part of a roof structure of the multiple-shell tank according to the embodiment of the present disclosure.

FIG. 4 is a schematic cross-sectional view of the heat insulation material supply unit according to a first modified embodiment of the present disclosure.

FIG. 5 is a schematic cross-sectional view illustrating a state in which the heat insulation material is replenished to a multiple-shell tank according to a second modified embodiment of the present disclosure.

### DESCRIPTION OF EMBODIMENTS

In the following, each embodiment of a multiple-shell tank according to the present disclosure will be described in detail with reference to the drawings. In the following, a triple-shell tank 1 will be described as an example of a multiple-shell tank. The triple-shell tank 1 is a tank that stores a low-temperature liquefied gas, and is a flat bottom tank having a ground stationary triple-shell structure. The stored liquefied gas is, for example, liquefied hydrogen.

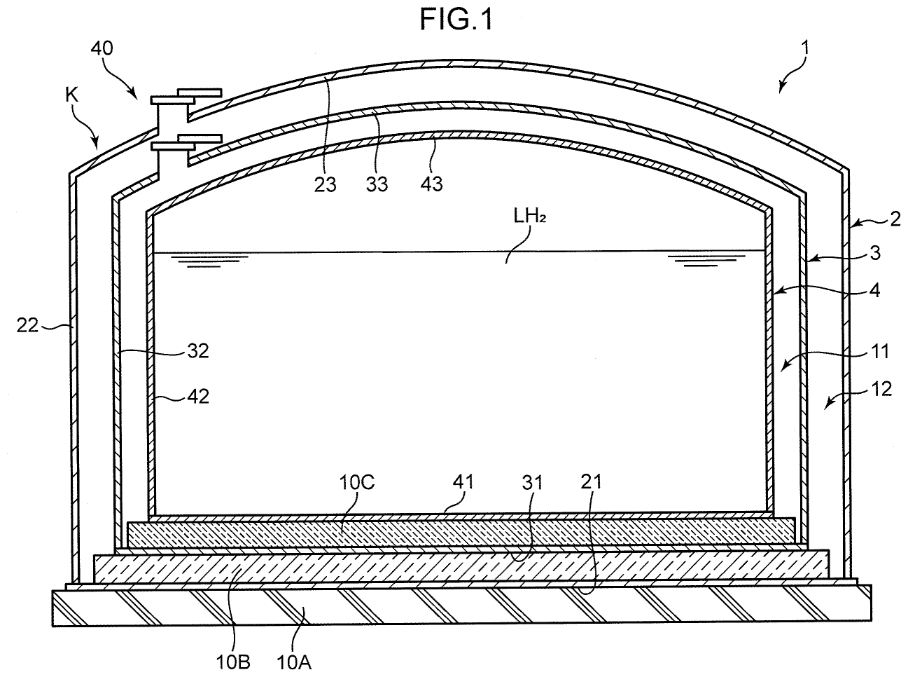

FIG. 1 is a longitudinal cross-sectional view of the triple-shell tank 1 according to an embodiment of the present disclosure. In FIG. 1, the triple-shell tank 1 stores liquefied hydrogen LH₂ as liquefied gas. The triple-shell tank 1 includes a tank foundation 10A, a first base part 10B, a second base part 10C, an outer tank 2 erected on the tank foundation 10A, an intermediate tank 3 contained in the outer tank 2, and an inner tank 4 contained in the intermediate tank 3. The outer tank 2, the intermediate tank 3, and the inner tank 4 each have a circular shape in top view, and are disposed concentrically.

The tank foundation 10A is a concrete layer serving as a foundation part of the triple-shell tank 1. The tank foundation 10A has a size larger than an outer diameter of the outer tank 2. The outer tank 2 is a sealed body made of metal such as carbon steel, and includes an outer tank bottom plate 21, an outer tank side plate 22, and an outer tank roof 23. The outer tank bottom plate 21 is laid immediately above the tank foundation 10A, and has a disc shape. The outer tank side plate 22 is erected from a peripheral edge of the outer tank bottom plate 21 and has a cylindrical shape. The outer tank roof 23 is attached to an upper end of the cylindrical outer tank side plate 22 so as to close an upper side opening of the outer tank side plate 22, and has a dome shape.

The intermediate tank 3 is a sealed body made of metal such as SUS, and is disposed inside the outer tank 2. The intermediate tank 3 includes an intermediate tank bottom plate 31, an intermediate tank side plate 32, and an intermediate tank roof 33. The intermediate tank bottom plate 31 has a disk shape having a diameter smaller than that of the outer tank bottom plate 21. The intermediate tank side plate 32 is erected from a peripheral edge of the intermediate tank bottom plate 31, and has a cylindrical shape. The intermediate tank roof 33 is attached to an upper end of the intermediate tank side plate 32 so as to close an upper side opening of the cylindrical intermediate tank side plate 32, and has a dome shape.

The first base part 10B is interposed between the outer tank bottom plate 21 and the intermediate tank bottom plate 31. The first base part 10B includes a concrete layer, a heat insulating layer, and the like, and supports the intermediate tank 3.

The inner tank 4 is a tub that actually stores liquid, is a sealed body made of metal such as SUS, and is disposed inside the intermediate tank 3. The inner tank 4 includes an inner tank bottom plate 41, an inner tank side plate 42, and an inner tank roof 43. The inner tank bottom plate 41 has a disk shape having a diameter smaller than that of the intermediate tank bottom plate 31. The inner tank side plate 42 is erected from a peripheral edge of the inner tank bottom plate 41 and has a cylindrical shape. The inner tank roof 43 is attached to an upper end of the inner tank side plate 42 so as to close an upper side opening of the cylindrical inner tank side plate 42, and has a dome shape. Liquefied hydrogen LH₂ at about −253° C. is stored in the inner tank 4.

The second base part 10C is interposed between the intermediate tank bottom plate 31 and the inner tank bottom plate 41. Similarly to the first base part 10B, the second base part 10C also includes a concrete layer, a heat insulating layer, and the like, and supports the inner tank 4.

A gap having a predetermined width is provided between the inner tank 4 and the intermediate tank 3 and between the intermediate tank 3 and the outer tank 2 in the triple-shell tank 1. A first inter-tub space 11, which is a gap between the inner tank 4 and the intermediate tank 3, and a second inter-tub space 12, which is a gap between the intermediate tank 3 and the outer tank 2, are filled with heat insulation material. As the heat insulation material, for example, a powder heat insulation material such as perlite can be used. The heat insulation material is not limited to powder, and may be in other forms such as a fibrous form. In addition, the first inter-tub space 11 is filled with a low-boiling point gas equivalent to the liquefied hydrogen LH₂ stored in the inner tank 4, for example, a hydrogen gas GH₂. The second inter-tub space 12 is filled with an inert gas having a boiling point higher than that of the gas filled in the first inter-tub space 11, for example, a nitrogen gas GN₂. In other words, for the triple-shell tank 1 described above, the intermediate tank 3 is disposed so as to cover the inner tank 4, and the first inter-tub space 11 is formed between the intermediate tank 3 and the inner tank 4. In addition, the outer tank 2 is disposed so as to cover the intermediate tank 3, and the second inter-tub space 12 is formed between the outer tank 2 and the intermediate tank 3. The first inter-tub space 11 corresponds to a first heat insulating space of the present disclosure. The second inter-tub space 12 corresponds to a second heat insulating space of the present disclosure.

As described above, in the present embodiment, the triple-shell tank 1 has a three-layer structure, the liquefied hydrogen LH₂ at −253° C. is stored in the inner tank 4, the hydrogen gas GH₂ is filled in the first inter-tub space 11, and the nitrogen gas GN₂ is filled in the second inter-tub space 12, so that a heat insulating function is provided stepwise. Since the first inter-tub space 11 and the second inter-tub space 12 are filled with heat insulation material such as perlite, the above-described heat insulating function is improved. However, it is difficult to supply and fill the first inter-tub space 11 with heat insulation material such as perlite from an outer space, which is a space outside the triple-shell tank 1, in a state where the triple-shell tank 1 is constructed as described above, i.e., in an assembled state.

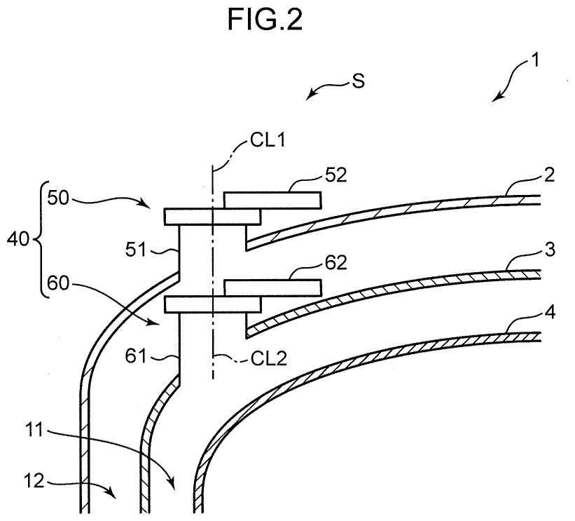

In order to solve such a problem, in the present embodiment, the triple-shell tank 1 further includes the heat insulation material supply unit 40. FIG. 2 is a schematic cross-sectional view of the heat insulation supply unit 40 according to the present embodiment. The heat insulation material supply unit 40 is disposed near a shoulder portion K of the triple-shell tank 1 in FIG. 1. The heat insulation material supply unit 40 enables heat insulation material to be supplied from an external space S of the triple-shell tank 1 to the first inter-tub space 11 (FIGS. 1 and 2). The heat insulation material supply unit 40 allows the external space of the triple-shell tank 1 and the first inter-tub space 11 to communicate with each other. The heat insulation material supply unit 40 corresponds to a communication part of the present disclosure. Specifically, the heat insulation material supply unit 40 includes an outer tank supply unit 50 and an intermediate tank supply unit 60. In addition, the heat insulation material supply unit 40 includes a part of the second inter-tub space 12.

The outer tank supply unit 50 is disposed at the outer tank 2. The outer tank supply unit 50 has an outer tubular part 51 and an outer lid part 52.

The outer tubular part 51 has a tubular shape extending along a first center line CL1. The outer tubular part 51 may have a cylindrical shape, a rectangular tubular shape, or the like. The same applies to other tubular parts to be described later. The outer tubular part 51 is disposed at the outer tank 2 so as to enable the external space S and the second inter-tub space 12 to communicate with each other, and allows heat insulation material to pass therethrough. The outer lid part 52 is a lid part capable of releasing and sealing the tubular part 51. The outer lid part 52 only needs to have a sealing function such as a blind flange. The outer lid part 52 may be welded to the outer tubular part 51. Also in this case, the structure of the outer tubular part 51 is included in the communicable communication part in the present disclosure. The same applies to other lid parts to be described later. Note that the outer tubular part 51 corresponds to an outer communication part of the present disclosure.

The intermediate tank supply unit 60 is disposed at the intermediate tank 3. The intermediate tank supply unit 60 includes an intermediate tubular part 61 and an intermediate lid part 62.

The intermediate tubular part 61 has a tubular shape extending along a second center line CL2. The intermediate tubular part 61 is disposed at the intermediate tank 3 so as to enable the first inter-tub space 11 and the second inter-tub space 12 to communicate with each other, and allows heat insulation material that has passed through the outer tubular part 51 to pass therethrough. The intermediate tubular part 61 is disposed below the outer tubular part 51. An inlet of the intermediate tubular part 61 is disposed in the second inter-tub space 12. The intermediate lid part 62 is a lid part capable of releasing and sealing the intermediate tubular part 61. The structure of the intermediate lid part 62 is also similar to that of the outer lid part 52. Note that the intermediate tubular part 61 corresponds to an inner communication part of the present disclosure.

Note that in the present embodiment, the first center line CL1 and the second center line CL2 are parallel to each other and disposed on the same straight line. The outer tubular part 51 and the intermediate tubular part 61 are disposed at the outer tank 2 and the intermediate tank 3, respectively, such that the first center line CL1 and the second center line CL2 are parallel to a vertical direction.

The outer tubular part 51 and the intermediate tubular part 61 have a circular tube shape having the same outer diameter. Therefore, when viewed along the first center line CL1 in FIG. 2, the outer tubular part 51 is disposed so as to overlap the intermediate tubular part 61. The outer tubular part 51 and the intermediate tubular part 61 may have outer diameters different from each other.

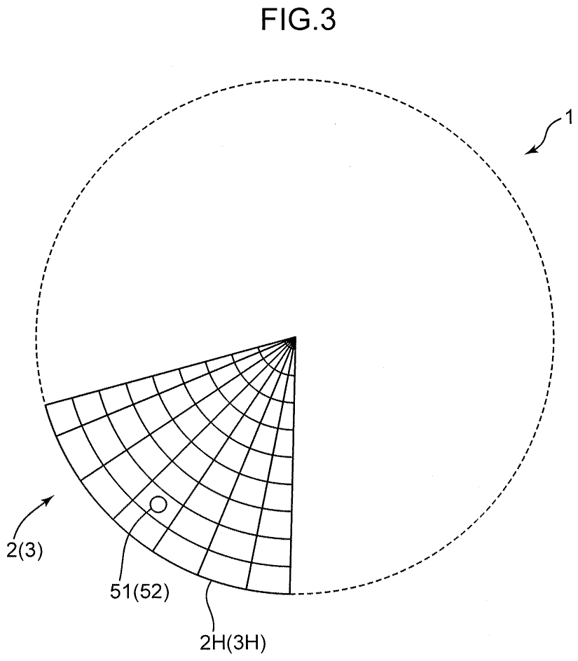

FIG. 3 is a plan view illustrating a part of a roof structure of the triple-shell tank 1 according to the present embodiment. The triple-shell tank 1 further includes an outer tank framework 2H and an intermediate tank framework 3H. The outer tank framework 2H is a framework supporting the outer tank 2, and the intermediate tank framework 3H is a framework supporting the intermediate tank 3. In FIG. 3, the intermediate tank framework 3H is disposed to be hidden below the outer tank framework 2H. The outer tank framework 2H and the intermediate tank framework 3H have the same arrangement structure in plan view, and are disposed radially in the present embodiment. In the plan view illustrated in FIG. 3, the outer tank framework 2H and the intermediate tank framework 3H are disposed so as to surround the outer tubular part 51 and the intermediate tubular part 61 of the heat insulation material supply unit 40. In other words, since neither the outer tank framework 2H nor the intermediate tank framework 3H is disposed in a region where the outer tubular part 51 and the intermediate tubular part 61 are disposed, the outer tubular part 51 disposed at the outer tank 2 and the intermediate tubular part 61 disposed at the intermediate tank 3 as illustrated in FIG. 2 can easily communicate with each other without interference from these framework structures.

Next, description will be made of a process of supplying perlite as an example of heat insulation material to the first inter-tub space 11 and the second inter-tub space 12 in the triple-shell tank 1 according to the present embodiment.

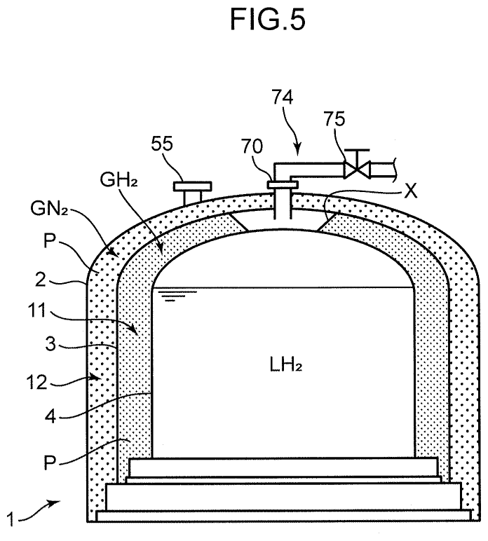

Prior to the perlite supply operation, the triple-shell tank 1 described above is constructed. In order to supply perlite into the triple-shell tank 1, an operator prepares a supply pipe 74 (see FIG. 5) through which perlite can be supplied. As an example, the supply pipe 74 is a rubber pipe. A valve 75 is disposed at the supply pipe 74, and the operator supplies perlite by opening the valve 75. The supply pipe 74 also corresponds to a part of the external space S described above.

In order to supply perlite to the first inter-tub space 11, the operator releases the outer tubular part 51 and the intermediate tubular part 61 by opening the outer lid part 52 and the intermediate lid part 62 in FIG. 2, respectively. As a result, the external space S and the first inter-tub space 11 communicate with each other via the outer tubular part 51, the second inter-tub space 12, and the intermediate tubular part 61. Next, the operator inserts the supply pipe 74 into the outer tubular part 51 and the intermediate tubular part 61, and supplies perlite from the external space S to the first inter-tub space 11 through the outer tubular part 51 and the intermediate tubular part 61. At this time, the operator inserts a pipe for supplying perlite (see the supply pipe 74 in FIG. 5) from the outer tubular part 51 to the intermediate tubular part 61. When the operation of supplying perlite to the first inter-tub space 11 is completed, the operator removes the above supply pipe 74 and seals the intermediate tubular part 61 with the intermediate lid part 62. The structure and the number of the above pipes may be changed according to the supply operation.

Next, after closing the intermediate tubular part 61 with the intermediate lid part 62 as described above, the operator inserts the supply pipe 74 into the outer tubular part 51 again, and supplies perlite from the external space S to the second inter-tub space 12. Then, after removing the supply pipe 74 from the outer tubular part 51, the operator seals the outer tubular part 51 with the outer lid part 52 to complete the supply of perlite to the second inter-tub space 12.

As described in the foregoing, in the present embodiment, the heat insulation material supply unit 40 enables the external space S of the triple-shell tank 1 and the first inter-tub space 11 to communicate with each other. Therefore, even if the second inter-tub space 12 independent of the first inter-tub space 11 is disposed outside the first inter-tub space 11, the heat insulation material can be supplied from the external space S of the triple-shell tank 1 to the first inter-tub space 11. The communication in the present embodiment means that the external space S and the first inter-tub space 11 communicate with each other via the outer tubular part 51, the opened second inter-tub space 12, and the intermediate tubular part 61.

In particular, in the present embodiment, the outer tank supply unit 50 is disposed at the outer tank 2, and the intermediate tank supply unit 60 is disposed at the intermediate tank 3, so that the heat insulation material can be supplied from the external space S to the first inter-tub space 11 through the outer tubular part 51 and the intermediate tubular part 61. Since the outer tubular part 51 and the intermediate tubular part 61 are independent from each other without being connected to each other, even if thermal shrinkage occurs in each tub of the triple-shell tank 1 due to an influence of liquefied hydrogen and a heat-insulating gas stored in the triple-shell tank 1, the outer tubular part 51 and the intermediate tubular part 61 are prevented from being damaged by a difference in a thermal shrinkage amount between the tubs.

In addition, in the present embodiment, since the first center line CL1 and the second center line CL2 are disposed on a straight line substantially parallel to a vertical line, the operator does not need to greatly change an orientation direction of the supply pipe 74 for supplying heat insulation material in the middle, and can easily insert the supply pipe 74 along a substantially vertical direction. Each center line may be disposed along a straight line parallel to the vertical line, or may be disposed so as to be inclined at a slight angle of, e.g., five degrees with respect to the vertical line.

### Modified Embodiments

Although one embodiment of the multiple-shell tank according to the present disclosure has been described in the foregoing, the present disclosure is not limited to the above embodiment at all. For example, the above-described triple-shell tank 1 can take the following modified embodiments.

In the above embodiment, the description has been made of the mode where the first center line CL1 of the outer tubular part 51 and the second center line CL2 of the intermediate tubular part 61 are disposed on the same axis. However, when viewed along the first center line CL1 in FIG. 2, at least a part of the outer tubular part 51 may be disposed so as to overlap the intermediate tubular part 61. In a case where a supply pipe 74 (FIG. 5) inserted into the outer tubular part 51 and the intermediate tubular part 61 is made of an elastic material such as rubber and is deformable in order to supply heat insulation material such as perlite, even if there is a deviation between the outer tubular part 51 and the intermediate tubular part 61 as described above, the pipe can be easily inserted into each tubular part to supply the heat insulation material to the first inter-tub space 11.

In addition, the outer tubular part 51 and the intermediate tubular part 61 may be disposed such that the first center line CL1 of the outer tubular part 51 and the second center line CL2 of the intermediate tubular part 61 are parallel to a normal line of the outer tank 2.

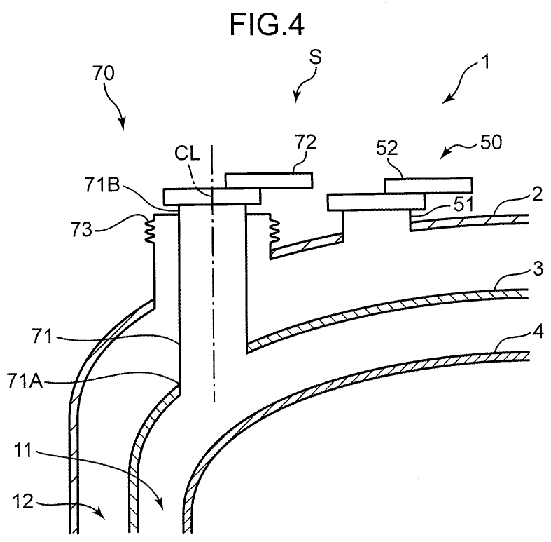

FIG. 4 is a schematic cross-sectional view of the heat insulation material supply unit according to a first modified embodiment of the present disclosure. In the present modified embodiment, the triple-shell tank 1 includes the heat insulation material supply unit 70 and an outer tank supply unit 50.

The heat insulation material supply unit 70 enables heat insulation material to be supplied from an external space S to a first inter-tub space 11. The heat insulation material supply unit 70 includes a connecting tubular part 71, a lid part 72, and an expandable tubular part 73.

The connecting tubular part 71 is made of a circular tube member that connects an outer tank 2 and an intermediate tank 3 so that the external space S and the first inter-tub space 11 communicate with each other. The connecting tubular part 71 has a proximal end portion 71A and a distal end portion 71B. The proximal end portion 71A is connected to the intermediate tank 3. The distal end portion 71B is disposed in the external space S on a side opposite to the proximal end portion 71A. The connecting tubular part 71 corresponds to a connecting part in the present disclosure.

The lid part 72 enables the connecting tubular part 71 to be released and sealed. The lid part 72 has the same structure as the outer lid part 52 and the intermediate lid part 62 described above. In the present modified embodiment, the lid part 72 is disposed so as to be able to seal the distal end portion 71B.

The expandable tubular part 73 is disposed so as to surround a part of the connecting tubular part 71 protruding outward from the outer tank 2. In addition, the expandable tubular part 73 connects the distal end portion 71B of the connecting tubular part 71 and the outer tank 2 to each other, and is expandable with respect to the outer tank 2 in a protruding direction of the connecting tubular part 71 and in a radial direction of the tank. The expandable tubular part 73 corresponds to an expandable part of the present disclosure.

The outer tank supply unit 50 has the same structure as that of the above embodiment and includes an outer tubular part 51 and an outer lid part 52. The outer tubular part 51 is disposed at the outer tank 2 at a position different from the connecting tubular part 71. In the present embodiment, the outer tubular part 51 is disposed adjacent to the connecting tubular part 71.

In the present modified embodiment, at the time of constructing the triple-shell tank 1, the heat insulation material supply unit 70, including the connecting tubular part 71 and the lid part 72, is disposed so as to be interposed between the outer tank 2 and the intermediate tank 3. In addition, the expandable tubular part 73 is disposed so as to surround the connecting tubular part 71.

Then, when supplying perlite to the first inter-tub space 11, the operator opens the lid part 72 to release the connecting tubular part 71, inserts the supply pipe 74 into the connecting tubular part 71, supplies the perlite from the external space S to the first inter-tub space 11 through the connecting tubular part 71, and then seals the connecting tubular part 71 with the lid part 72.

Thus, in the present modified embodiment, the heat insulation material can be directly supplied from the external space S to the first inter-tub space 11 through the heat insulation material supply unit 70 without passing through the second inter-tub space 12. Therefore, as in the above embodiment, the heat insulation material can be easily supplied to the first inter-tub space 11 without opening and closing the two lid parts of the outer lid part 52 and the intermediate lid part 62, respectively. Note that the communication in the present modified embodiment means that the external space S and the first inter-tub space 11 communicate with each other via the connecting tubular part 71.

Note that, as described above, when the operation of supplying to the first inter-tub space 11 is completed, the operator supplies the perlite to the second inter-tub space 12 through the outer tank supply unit 50. Specifically, the operator opens the outer lid part 52 to release the outer tubular part 51, and supplies perlite from the external space S to the second inter-tub space 12 through the outer tubular part 51. Then, the operator seals the outer tubular part 51 with the outer lid part 52 to complete the supply of the perlite to the second inter-tub space 12.

Thus, in the present modified embodiment, perlite can be supplied from the outer tank supply unit 50 independent of the heat insulation material supply unit 70 to the second inter-tub space 12. Therefore, by preparing the plurality of supply pipes 74, the operation of supplying to the first inter-tub space 11 and to the second inter-tub space 12 can be efficiently executed in parallel.

After the perlite is supplied to the first inter-tub space 11 and to the second inter-tub space 12, the hydrogen gas is supplied as a low-temperature gas to the first inter-tub space 11, and the nitrogen gas is similarly supplied to the second inter-tub space 12 as described above. These low-temperature gases are set at different temperatures. In this case, since a thermal shrinkage amount of the intermediate tank 3 is larger than a thermal shrinkage amount of the outer tank 2, an interval between the outer tank 2 and the intermediate tank 3 in FIG. 4 is larger than that at room temperature. At this time, the distal end portion 71B of the connecting tubular part 71 in FIG. 4 is displaced so as to be retracted inward. However, in the present modified embodiment, since the expandable tubular part 73 that is expandable is disposed so as to surround the connecting tubular part 71, the expandable tubular part 73 can expand and contract in accordance with a displacement of the connecting tubular part 71 as described above.

FIG. 5 is a schematic cross-sectional view illustrating a state in which heat insulation material is replenished to a triple-shell tank 1 according to a second modified embodiment of the present disclosure. In the present modified embodiment, the heat insulation material supply unit 70 is disposed corresponding to a top portion of the triple-shell tank 1. As in the first modified embodiment described above, when the supply of a perlite P to a first inter-tub space 11 and a second inter-tub space 12 is completed and a liquefied hydrogen, as a storage object, is stored in an inner tank 4, the inner tank 4 is contracted by cold heat of the liquefied hydrogen. As a result, as shown in FIG. 5, for example, a part of the perlite P filled in around a top portion of the inner tank 4 may settle like a sediment portion X in FIG. 5 as the inner tank 4 contracts. Such a phenomenon may also occur around a shoulder portion of the triple-shell tank 1.

Even when the perlite has settled as sediment as described above, in the present modified embodiment, a supply pipe 74 in FIG. 5 is connected to the heat insulation material supply unit 70 (FIG. 4), and a valve 75 is opened, so that the perlite can be replenished to the first inter-tub space 11 through the supply pipe 74 and the heat insulation material supply unit 70. Since the first inter-tub space 11 is filled with the hydrogen gas as described above, it is desirable that the inside of the supply pipe for perlite, including the supply pipe 74 of FIG. 5, is purged with hydrogen gas in advance. As a result, air is prevented from being mixed into the first inter-tub space 11 at the time of supplying the perlite.

Although in each of the above embodiments, the triple-shell tank 1 has been described as the multiple-shell tank of the present disclosure, the present disclosure is not limited thereto.

The present disclosure may be applied to a tank of a quadruple-shell or more as a multiple-shell tank. In other words, at least one of the outer tank, the intermediate tank, and the inner tank in the present disclosure may have a plurality of tubs including a heat insulating space therebetween.

Furthermore, when an outer tank supply unit 50 and an intermediate tank supply unit 60 are disposed as the heat insulation material supply unit 40, a first center line CL1 of an outer tubular part 51 and a second center line CL2 of an intermediate tubular part 61 may not be parallel to each other. Furthermore, these center lines may extend along a direction different from a vertical direction and from a normal direction of the triple-shell tank 1. In addition, each lid part may be detachable, or may be joined by welding or the like after operation of supplying heat insulation material.

In each of the above embodiments, after construction of the triple-shell tank 1, the heat insulation material may be filled through the heat insulation material supply units 40 and 70 in a state where no hydrogen gas is filled in the first inter-tub space 11, or the heat insulation material may be replenished through the heat insulation material supply units 40 and 70 in a state where the hydrogen gas is filled while the tank operates. Note that, in addition to the communication pipe for supplying heat insulation material as described above, an opening for allowing an operator to enter and exit may be formed in a sealable manner at an outer tank 2 and an intermediate tank 3 of the triple-shell tank 1.

### Conclusion of Present Disclosure

The specific embodiments described above include disclosure having the following configurations.

A multiple-shell tank according to a first aspect of the present disclosure includes: an inner tank that stores a liquefied gas; an intermediate tank that covers the inner tank and forms a first heat insulating space between the intermediate tank and the inner tank; an outer tank that covers the intermediate tank and forms a second heat insulating space between the outer tank and the intermediate tank; and a communication part enabling an external space and the first heat insulating space to communicate with each other, the external space being a space outside the multiple-shell tank.

According to this configuration, with the first heat insulating space and the second heat insulating space being disposed by the outer tank, the intermediate tank, and the inner tank, heat insulation material can be supplied from an outer space to the first heat insulating space.

A multiple-shell tank according to a second aspect of the present disclosure is the multiple-shell tank according to the first aspect, in which the communication part includes: an outer communication part that extends along a first center line and is disposed at the outer tank so as to allow the external space and the second heat insulating space to communicate with each other; and an inner communication part that is disposed to be opposed to the outer communication part, extends along a second center line, and is disposed at the intermediate tank so as to allow the first heat insulating space and the second heat insulating space to communicate with each other.

According to this configuration, the outer communication part is disposed at the outer tank, and the inner communication part is disposed at the intermediate tank, so that the heat insulation material can be supplied from the external space to the first heat insulating space through the outer communication part, the second heat insulating space, and the inner communication part. Since the outer communication part and the inner communication part are independent from each other without being connected to each other, even if thermal shrinkage occurs in each tub of the multiple-shell tank due to an influence of a storage material and a heat-insulating gas in the multiple-shell tank, it is possible to prevent the heat insulation material supply unit from being damaged by a difference in a thermal shrinkage amount between the tubs.

A multiple-shell tank according to a third aspect of the present disclosure is the multiple-shell tank according to the second aspect, in which the first center line and the second center line are disposed on a straight line substantially parallel to a vertical line.

According to this configuration, an operator can easily insert a pipe into each communication part along a vertical direction.

A multiple-shell tank according to a fourth aspect of the present disclosure is the multiple-shell tank according to the first aspect, in which the communication part includes a connecting part that connects the outer tank and the intermediate tank to each other so as to allow the external space and the first heat insulating space to communicate with each other.

According to this configuration, the heat insulation material can be directly supplied from the external space to the first heat insulating space through the connecting part. Therefore, the heat insulation material can be easily supplied to the first heat insulating space.

A multiple-shell tank according to a fifth aspect of the present disclosure is the multiple-shell tank according to the fourth aspect, in which the connecting part has a proximal end portion connected to the intermediate tank and a distal end portion disposed in the external space on a side opposite to the proximal end portion, and the communication part further includes an expandable part that connects the distal end portion of the connecting part and the outer tank to each other and is expandable with respect to the outer tank.

According to this configuration, even when the thermal shrinkage amounts of the outer tank and the intermediate tank are different, the expandable part can expand and contract in accordance with a displacement of the connecting part.

A multiple-shell tank according to a sixth aspect of the present disclosure is the multiple-shell tank according to the fourth or fifth aspect, further including an outer communication part disposed at the outer tank at a position different from the connecting part so as to allow the external space and the second heat insulating space to communicate with each other.

According to this configuration, the heat insulation material can be supplied from the outer communication part independent of the connecting part to the second heat insulating space. Therefore, it is possible to efficiently execute the operation of supplying the heat insulation material to the first heat insulating space and the second heat insulating space.

A multiple-shell tank according to a seventh aspect of the present disclosure is the multiple-shell tank according to the first to sixth aspects, further including: an outer tank framework supporting the outer tank; and an intermediate tank framework supporting the intermediate tank, in which the outer tank framework and the intermediate tank framework being disposed so as to surround the communication part in plan view.

According to this configuration, the external space and the first heat insulating space can easily communicate with each other through the communication part without interference from each framework structure.

An heat insulation material supply method for a multiple-shell tank according to another aspect of the present disclosure is a heat insulation material supply method for a multiple-shell tank including an inner tank that stores a liquefied gas; an intermediate tank that covers the inner tank and forms a first heat insulating space between the intermediate tank and the inner tank; and an outer tank that covers the intermediate tank and forms a second heat insulating space between the outer tank and the intermediate tank, the method including: supplying heat insulation material from an external space to the first heat insulating space through a communication part enabling the external space and the first heat insulating space to communicate with each other, the external space being a space outside the multiple-shell tank.

According to this method, the heat insulation material can be supplied from the external space to the first heat insulating space in the multiple-shell tank in which the first heat insulating space and the second heat insulating space are disposed by the outer tank, the intermediate tank, and the inner tank.

### REFERENCE SIGNS

1 triple-shell tank
2 outer tank
23 outer tank roof
2H outer tank framework
3 intermediate tank
33 intermediate tank roof
3H intermediate tank framework
4 inner tank
43 inner tank roof
10A tank foundation
10B first base part
10C second base part
11 first inter-tub space
12 second inter-tub space
40,70 heat insulation material supply unit
50 outer tank supply unit
51 outer tubular part
52 outer lid part
60 intermediate tank supply unit
61 intermediate tubular part
62 intermediate lid part
71 connecting tubular part
72 lid part
73 expandable tubular part
74 supply pipe
75 valve

1. A multiple-shell tank comprising:
an inner tank that stores a liquefied gas;
an intermediate tank that covers the inner tank and forms a first heat insulating space between the intermediate tank and the inner tank;
an outer tank that covers the intermediate tank and forms a second heat insulating space between the outer tank and the intermediate tank; and
a communication part enabling an external space and the first heat insulating space to communicate with each other, the external space being a space outside the multiple-shell tank.

2. The multiple-shell tank according to claim 1, wherein
the communication part includes:
an outer communication part that extends along a first center line and is disposed at the outer tank so as to allow the external space and the second heat insulating space to communicate with each other; and
an inner communication part that is disposed to be opposed to the outer communication part, extends along a second center line, and is disposed at the intermediate tank so as to allow the first heat insulating space and the second heat insulating space to communicate with each other.

3. The multiple-shell tank according to claim 2, wherein the first center line and the second center line are disposed on a straight line substantially parallel to a vertical line.

4. The multiple-shell tank according to claim 1, wherein the communication part includes a connecting part that connects the outer tank and the intermediate tank to each other so as to allow the external space and the first heat insulating space to communicate with each other.

5. The multiple-shell tank according to claim 4, wherein
the connecting part has a proximal end portion connected to the intermediate tank and a distal end portion disposed in the external space on a side opposite to the proximal end portion, and
the communication part further includes an expandable part that connects the distal end portion of the connecting part and the outer tank to each other and is expandable with respect to the outer tank.

6. The multiple-shell tank according to claim 4, further comprising an outer communication part disposed at the outer tank at a position different from the connecting part so as to allow the external space and the second heat insulating space to communicate with each other.

7. The multiple-shell tank according to claim 1, further comprising:
an outer tank framework supporting the outer tank; and
an intermediate tank framework supporting the intermediate tank,
wherein the outer tank framework and the intermediate tank framework are disposed so as to surround the communication part in plan view.

8. An heat insulation material supply method for a multiple-shell tank, the multiple-shell tank including an inner tank that stores a liquefied gas; an intermediate tank that covers the inner tank and forms a first heat insulating space between the intermediate tank and the inner tank; and an outer tank that covers the intermediate tank and forms a second heat insulating space between the outer tank and the intermediate tank, the method comprising:
supplying heat insulation material from an external space to the first heat insulating space through a communication part enabling the external space and the first heat insulating space to communicate with each other, the external space being a space outside the multiple-shell tank.
